(19) United States
(12) Patent Application Publication
(10) Pub. No.: US 2019/0358861 A1
(43) Pub. Date: Nov. 28, 2019

(54) INSULATING PLATE, INSULATING STRUCTURE FOR TIRE VULCANIZERS, AND METHOD OF VULCANIZING GREEN TIRES

(71) Applicant: ICHIMARU-GIKEN CO., LTD., Chikugo-shi (JP)

(72) Inventor: Hironobu ICHIMARU, Chikugo-shi (JP)

(21) Appl. No.: 16/461,764

(22) PCT Filed: Dec. 12, 2016
(86) PCT No.: PCT/JP2016/086894

§ 371 Date: May 16, 2019

(51) Int. Cl. B29C 35/02; B29C 33/02

(52) U.S. Cl. CPC B29C 35/02; B29C 2035/0211; B29C 33/02

(57) ABSTRACT

A heat insulating plate includes a base material and a reinforcement member attached to the base material. The base material is obtained by forming a sheet-shaped glass fiber cloth having a thickness of 0.5 mm. Further, twelve reinforcement members are attached to one base material. The reinforcement members have a role of ensuring the strength of the heat insulating plate by being in contact with the plate and the platen on the upper and lower end faces. The reinforcement members are formed in a stripe shape and are formed of a metal material having a thickness of about 1 to 10 mm, The metal material having excellent compressive strength and bending strength, such as iron, stainless steel, or titanium alloy, may be adopted.

### TECHNICAL FIELD

The present disclosure relates to a heat insulating plate, a heat insulating structure for a tire vulcanizer, and a method of vulcanizing a green tire. Particularly, the present disclosure relates to a heat insulating plate having a sufficient heat insulating property and excellent strength, a heat insulating structure of a tire vulcanizer, and a method of vulcanizing a green tire.

### BACKGROUND ART

In the manufacture of a tire, a green tire molded in advance into a shape close to that of the finished product is placed in a mold, and pressurized and heated. Inside a container of a tire vulcanizer, a mold configured to shape the external shape of a tire, a green tire disposed inside the mold, and a bladder disposed in the green tire are disposed.

Inside the bladder, a high-temperature, high-pressure fluid such as steam or gas is supplied or discharged from platens disposed above and below the container, and the green tire is pressed against the mold from the inside to form the shape of the tire.

Here, in order to improve the efficiency of manufacture of the tire, the tire vulcanizer adopts a structure in which a heat insulating plate is disposed outside the container and the platens to suppress the diffusion of heat. The heat insulating plate is disposed between the platens and the upper and lower plates, which fix and restrain the movement of opening the container during tire vulcanization.

For example, there is a structure of a tire vulcanizer described in Patent Document 1, which pertains to the arrangement position of a heat insulating plate of a general tire vulcanizer.

Here, the structure around the mold of the tire vulcanizer illustrated in FIG. 3 is described in Patent Document 1. The tire vulcanizer illustrated in FIG. 3 has a segment mold 101 in which multiple segments 100, which are radially expanded and contracted, are arranged. An upper platen 102 and a lower platen 103 are mounted above and below the segment mold 101.

In addition, an upper heat insulating plate 104 is disposed above the upper platen 102, and a lower heat insulating plate 105 is disposed below the lower platen 103. A top plate 106 is attached to the upper side of the upper heat insulating plate 104, and a bottom plate 107 is attached to the lower side of the lower heat insulating plate 105.

When the tire is vulcanized in the segment mold 101 (container), since a force to open the mold is applied, the segment mold 101, the top mold platen 102, and the bottom platen 103 are fastened and restrained by the top plate 106 and the bottom plate 107, respectively, and each plate serves as a frame.

As an example of a conventional heat insulating plate, a conventional heat insulating plate has a shape illustrated in FIG. 4A or FIG. 4B. The heat insulating plate 108 and the heat insulating plate 109 illustrated here are flat plates formed of one type of a heat insulating material.

### PRIOR ART DOCUMENT

### Patent Document

Patent Document 1: Japanese Laid-Open Patent Publication No. 2004-345086

### DETAILED DESCRIPTION OF THE INVENTION

Technical Problem

As a heat insulating plate in the conventional device including the tire vulcanizer described in Patent Document 1, a heat insulating plate formed of a material that is excellent in heat insulating property and compressive strength and is advantageous from the aspect of cost, such as calcium silicate or cement, has been widely used.

However, it has been found that the heat insulating plate formed of the material such as calcium silicate or cement is hard due to the hygroscopic property thereof, and is brittle due to the low bending strength thereof. Thus, cracks are generated in the heat insulating plates due to warpage of the upper and lower plates at the time of pressurization and impact at the time of opening and closing the upper and lower plates, and the heat insulating plate becomes worn out.

In the tire vulcanizer, the load applied to the heat insulating plate and the orientation of the heat insulating plates change depending on the force applied to the apparatus at the time of pressurization and the operating state of the mold and peripheral equipment. Thus, in order to ensure that the heat insulating plate is not damaged, the bending strength of the material and the mounting structure and shape of the heat insulating plate are important.

As the material of the heat insulating plate, a resin-based material has also been adopted. A resin-based heat insulating plate has advantages of high compressive strength and bending strength and low hygroscopicity, but the thermal conductivity thereof is larger than that of calcium silicate or the like. Thus, the heat insulating property of the resin-based heat insulating plate is insufficient.

Furthermore, in consideration of ensuring strength, heat insulating plates formed of a metal material such as iron or stainless steel also exist. In this case, the heat insulating plates have excessive strength equal to or higher than the strength required to withstand the operation of the tire vulcanizer, but on the other hand, the heat insulating plates become further insufficient in terms of the heat insulating property.

As described above, it is strongly required that the heat insulating plates used in the tire vulcanizer have both adiabaticity and strength adequately.

The present disclosure has been made in consideration of the above points, and more particularly, the present disclosure aims to provide a heat insulating plate, a heat insulating structure of a tire vulcanizer, and a method of vulcanizing a green tire, which have sufficient heat insulating properties and are also excellent in strength.

### Technical Solution

In accordance with an aspect, a heat insulating plate of the present disclosure includes: a base part disposed between a platen configured to sandwich a container, configured to clamp, vulcanize, and mold a green tire therein, and to supply steam to the container and a plate disposed outside the platen and configured to fasten the container and the platen, the base part including multiple openings formed therein; and a reinforcement member provided at at least one of positions corresponding to the openings in the base part to be in contact with the platen and the plate, the reinforcement member having a thermal conductivity higher than a thermal conductivity of the base part.

Here, by the base part interposed between the platen configured to sandwich a container configured to clamp, vulcanize, and mold a green tire therein and to supply steam to the container and a plate disposed outside the platen and configured to fasten the container and the platen, and having multiple openings formed therein, it is possible to provide a structure that suppresses the heat generated by the steam inside the container and the platen from diffusing to the outside.

In addition, by the reinforcement member, which is provided at a position corresponding to at least some of the openings in the base part to be in contact with the platen and the plate and has a thermal conductivity higher than that of the base part, it is possible to impart a certain strength to the heat insulating plate. That is, by using a material having a thermal conductivity higher than that of the base part as the reinforcement member, a material having a higher density than the material of the base part, in other words, a material having a high compressive strength or bending strength, is used, and it is possible to improve the strength of the heat insulating plate. In addition, since the reinforcement member is in contact with the platen and the plate, for example, it is possible to cause the force applied to the heat insulating plate to be firmly received at the position of the reinforcement member at the time of pressurization. A clear correlation (a relationship in which the density becomes large when the thermal conductivity is large) is not necessarily established between the thermal conductivity and the density. However, in a material used in the heat insulating plate of the tire vulcanizer of the present disclosure, since the density tends to increase as the thermal conductivity increases, the above-mentioned advantages occur.

When the thermal conductivity of the base part is 0.05 W/(m·K) or less, it is possible to provide a structure in which the heat generated by the steam inside the container and the platen hardly diffuses to the outside.

Here, when the thermal conductivity of the base part exceeds 0.05 W/(m·K), the heat insulating property of the base part may be insufficient.

In addition, when the thermal conductivity of the reinforcement member has a value larger than 0.1 W/(m·K), the strength of the heat insulating plate is further improved.

Here, when the thermal conductivity of the reinforcement member is 0.1 W/(m·K) or less, the density of the material forming the reinforcement member may decrease and the strength of the heat insulating plate may become weak.

Further, when multiple reinforcement members are provided and arranged substantially uniformly from the center of the base part as a starting point, the strength of the heat insulating plate is further improved, which makes it easy to uniformly strengthen the entire heat insulating plate.

In addition, when the multiple reinforcement members are the same thickness, that is, for example, the reinforcement members are more likely to receive the force applied to the heat insulating plate at the time of pressurization, thereby improving the durability of the heat insulating plate. In addition, a gap is unlikely to be generated between the reinforcement member and the platen, or between the reinforcement member and the plate, and it becomes easy to further suppress the diffusion of heat.

When an elastic gap filler is disposed between the base part and the reinforcement member, it is possible to further improve the heat insulating property. That is, for example, when the reinforcement member is attached to a hole formed by hollowing out a part of the base plate, a gap generated between both members is filled with a gap filler and thus heat hardly passes through the gap, thereby improving the heat insulating property. The gap filler referred to herein means, for example, one formed of foamed rubber.

In accordance with an aspect, a heat insulating structure of a tire vulcanizer of the present disclosure includes: a container configured to clamp a green tire therein to vulcanize and mold the green tire; a pair of platens configured to sandwich the container from above and below to supply steam to the container; a pair of plates disposed outside the platens, respectively, and configured to fasten the container and the platens; a base part interposed between the container and each of the plates, the base part including multiple openings formed therein; and a heat insulating plate including a reinforcement member provided at at least one of positions corresponding to the openings in the base part to be in contact with the platen and the plate, the reinforcement member having a thermal conductivity higher than that of the base part.

Here, by the base part interposed between the container and the plate and having multiple openings formed therein, it is possible to provide a structure in which the heat generated by the steam inside the container and the platen hardly diffuses to the outside.

In addition, by the reinforcement member, which is provided at a position corresponding to at least some of the openings in the base part to be in contact with the platen and the plate and has a thermal conductivity higher than that of the base part, it is possible to impart a certain strength to the heat insulating plate.

In accordance with an aspect, in a method of vulcanizing a green tire according to the present disclosure, when a green tire is clamped, vulcanized, and molded in a mold part of a container, a heat insulating plate, including a base part having multiple openings therein and a reinforcement member provided at at least one of positions corresponding to the openings in the base part to be in contact with a platen and a plate and having a thermal conductivity higher than that of the base part, is disposed between the container and the plate to provide heat insulation.

Here, since the heat insulating plate, including a base part having multiple openings therein and a reinforcement member provided at at least one of positions corresponding to the openings in the base part to be in contact with the platen and the plate and having a thermal conductivity higher than that of the base part, is interposed between the container and a plate to provide heat insulation, it is possible to suppress the heat generated by the steam inside the container and the platen from diffusing to the outside.

In addition, it is possible to withstand the pressure applied to the heat insulating plate when the green tire is vulcanized and molded, and it is possible to suppress the heat insulating plate from being damaged.

### Advantageous Effects

The heat insulating plate according to the present disclosure has sufficient heat insulating properties and is also excellent in strength. In addition, the heat insulating structure of a tire vulcanizer according to the present disclosure has satisfactory heat insulating properties and is also excellent in strength. Further, the method of vulcanizing a green tire according to the present disclosure has satisfactory heat insulating properties and is also excellent in strength.

### BRIEF DESCRIPTION OF THE DRAWINGS

FIGS. 1A and 1B are schematic views each illustrating an exemplary structure of a heat insulating plate to which the present disclosure is applied.

FIGS. 2A and 2B are schematic views each illustrating another exemplary structure of a heat insulating plate to which the present disclosure is applied.

FIG. 3 is a schematic view illustrating a structure of an arrangement position of a heat insulating plate of a conventional tire vulcanizer.

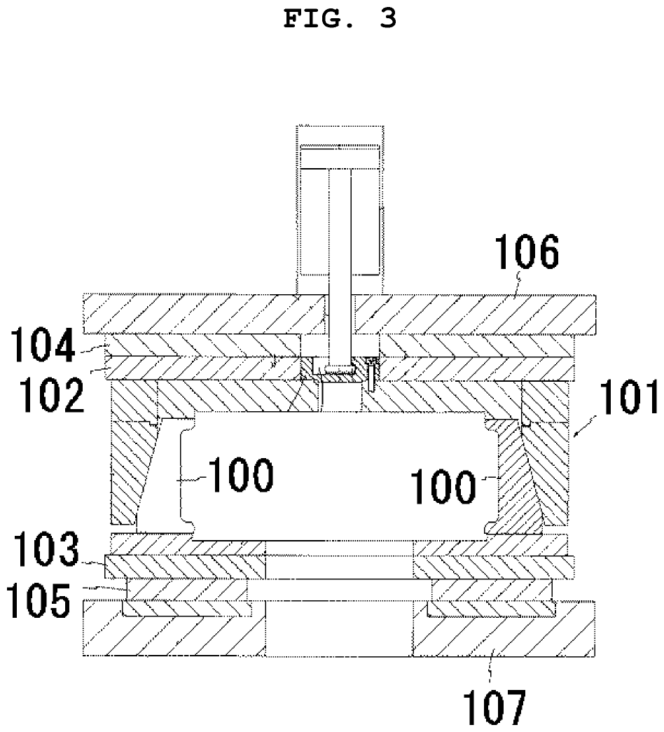

FIGS. 4A and 4B are schematic views each illustrating the shape of a heat insulating plate of a conventional tire vulcanizer.

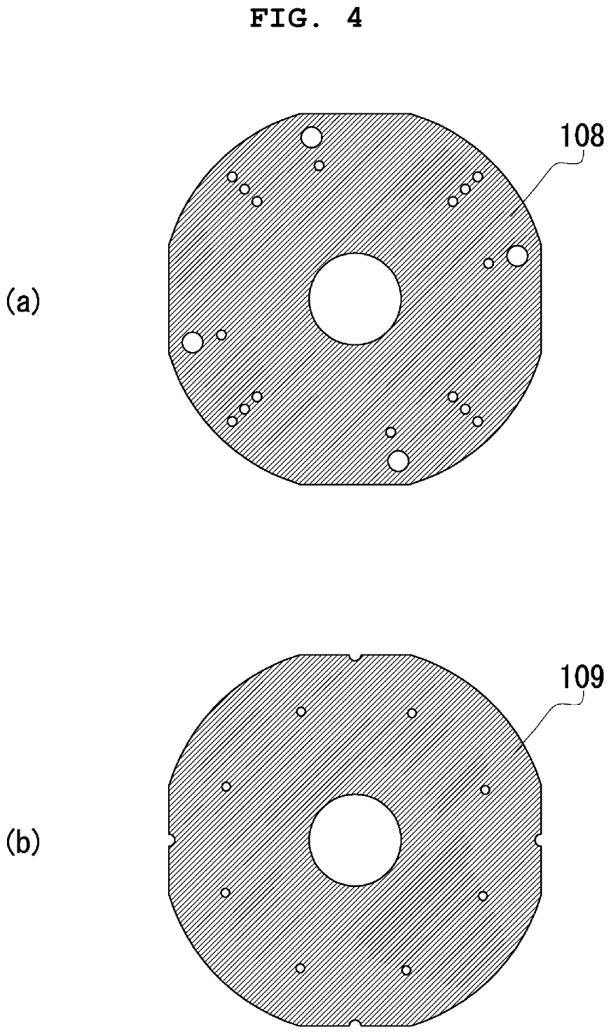

### MODE FOR CARRYING OUT THE INVENTION

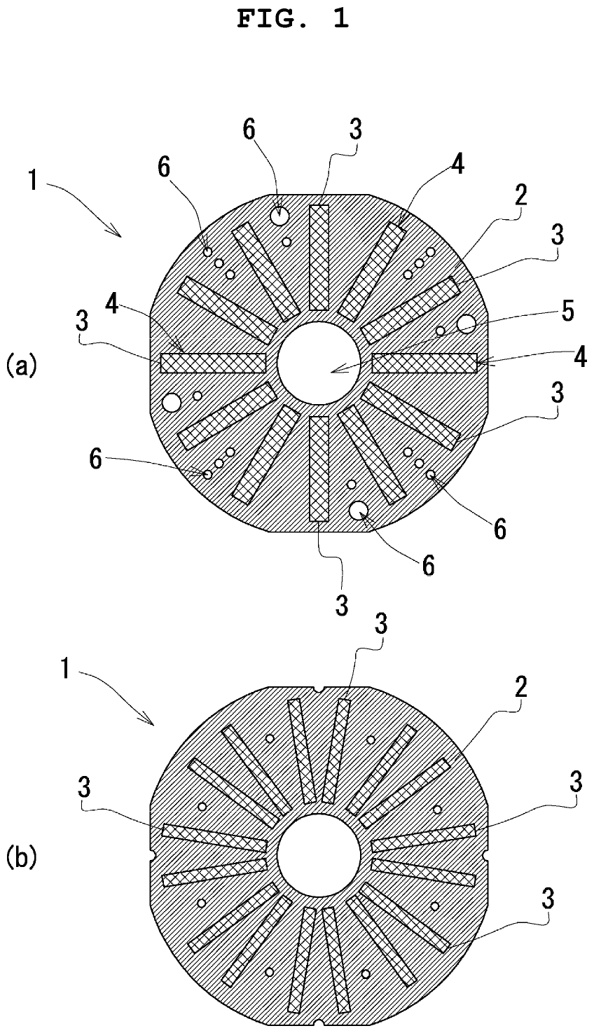

Hereinafter, embodiments of the present disclosure will be described with reference to the drawings to aid in understanding of the present disclosure. FIGS. 1A and 1B are schematic views each illustrating an exemplary structure of a heat insulating plate to which the present disclosure is applied. The structure illustrated below is an example of the present disclosure, and the contents of the present disclosure are not limited thereto.

As illustrated in FIG. 1A, a heat insulating plate 1 as an example of a heat insulating plate to which the present disclosure is applied includes a base material 2 and reinforcement members 3 attached to the base material 2.

The base material 2 is disposed between an upper platen and an upper plate or between a lower platen and a lower plate of a tire vulcanizer (not illustrated), and is a main material that suppresses diffusion of heat of a container and each platen of the tire vulcanizer.

The base material 2 has an effect of preventing energy loss as heated air flows to the platens (not illustrated) heated with a high-temperature, high-pressure fluid such as steam or gas. In addition, the base material 2 also has an effect of preventing the upper and lower plates (not illustrated) from being heated by radiant heat emitted from the platens heated by steam or the like.

The base material 2 is obtained by forming a sheet-shaped glass fiber cloth having a thickness of 0.5 mm and cutting the glass fiber cloth into the shape illustrated in FIG. 1B. In addition, in the base member 2, reinforcement member mounting holes 4 (corresponding to the openings in claim 1 of the present application) for the reinforcement members are formed at the mounting position of the reinforcement members 3.

The base member 2 has a central through hole 5 formed in the center thereof. In addition, in the base member 2, mounting through holes 6 are formed in some places. The center through hole 5 is a through hole configured to insert therethrough a cylinder rod (not shown) of an extension device, which is responsible for opening and closing a segment of a segment molding type tire vulcanizer. The mounting through holes 6 are through holes each configured to inserting therethrough a mounting member such as a screw to fix the heat insulating plate 1 to a platen or a plate.

The physical properties of the glass fiber cloth of the base material 2 include heat resistant temperature of 300° C. and a thermal conductivity of 0.047 W/(m·K).

Here, it is not necessary to fix the base member 2 to the platen or the plate via the mounting through holes 6 and the mounting members such as screws, and it is sufficient if the base member 2 is stably installed between the platen and the plate. For example, a structure in which the opposite ends of the sheet-shaped base material 2 are fixed and stretched may also be adopted. In addition, when the base material 2 and the reinforcement members 3 are the same thickness, it is also conceivable to fix the base material 2 to a platen or a plate using an adhesive. However, from the viewpoint of enhancing the effect of preventing diffusion of thermal energy by the above-described base material 2 and the effect of preventing heating of the plate, it is desirable to attach the base material 2 to a platen or a plate without a gap therebetween.

In addition, the shape and size of the base member 2 are not necessarily limited to those illustrated in FIG. 1A, and may be appropriately set in accordance with the shape and size of a platen or a plate of a tire vulcanizer provided with the heat insulating plate 1. Likewise, it is assumed that a base material 2 having a shape in which no central through hole 5 is formed is also used. For example, depending on the type of the tire vulcanizer, there is also the case in which the upper heat insulating plate above the upper platen is provided with the center through hole and the lower heat insulating plate below the lower platen is not provided with the central through hole.

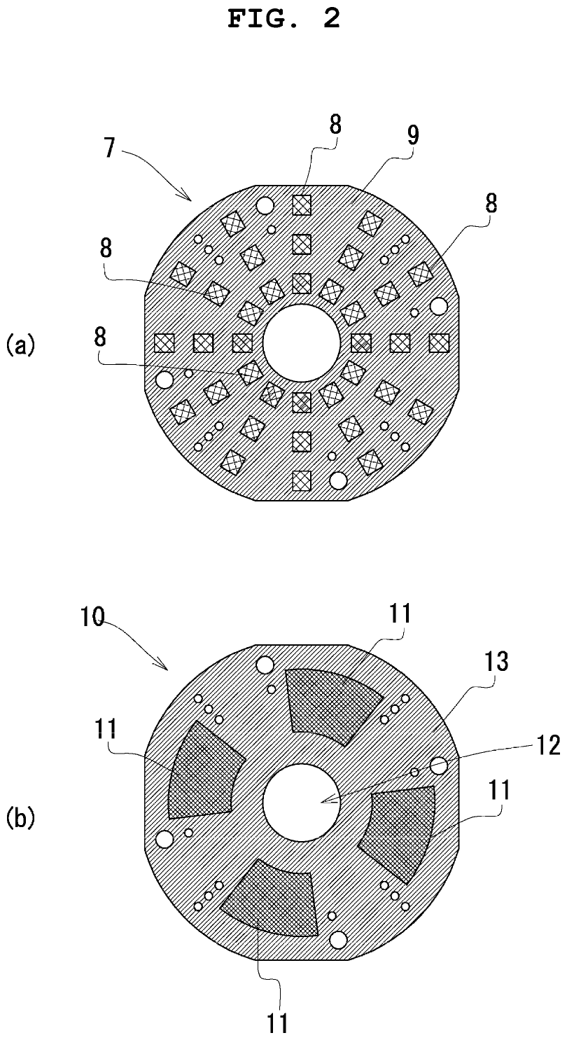

In addition, the shape of the base member 2 is not limited to one having the one-piece shape illustrated in FIGS. 1A and 1B or FIGS. 2A and 2B, and it is also possible to adopt a divided structure composed of multiple members divided into two or four depending on the structure of the tire vulcanizer (the structure of the attachment place of a platen or a plate) as long as the shape of the base material 2 is moldable. However, from the viewpoint of structural stability after mounting and ease of handling, it is desirable to form the base material 2 in a one-piece form.

The base material 2 is not necessarily formed of a sheet-shaped glass fiber cloth having a thickness of 0.5 mm. However, from the viewpoint of enhancing the effect of preventing diffusion of thermal energy and the effect of preventing heating of the plate by the above-described base material 2, it is preferable to select a material in consideration of a thermal conductivity and a thermal emissivity. As a desirable example of the material for the base material 2, it is desirable to form the base material 2 of a highly heat-insulating material, for example, a material having a thermal conductivity of 0.05 W/(m·K) or less.

Materials capable of being adopted as the base material 2 include, for example, foamed plastic-based materials such as polyurethane foam and phenol foam, and materials obtained by mixing fibrous materials such as rock wool and glass fiber with the foamed plastic-based materials.

For example, in the case of polyurethane foam or phenol foam, there are many materials having a thermal conductivity in the range of 0.02 to 0.049 W/(m·K), and depending on the type thereof, materials having a thermal conductivity of 0.02 W/(M·K) or less also exist. In addition, there are many materials having a density of about 10 to 45 kg/m³.

Further, it is not always necessary that the base material 2 be formed of a sheet-shaped glass fiber cloth having a thickness of 0.5 mm, and a flat base material may also be adopted. For example, as the base material of the above-mentioned polyurethane foam, one having a thickness of about several millimeters to several tens of millimeters may be used. By using a flat base material, there is also an advantage in that attachment of the reinforcement members 3 and work of aligning the thicknesses of the base material 2 and the reinforcement members 3 become easy.

As illustrated in FIG. 1A, twelve reinforcement members 3 are attached to one base material 2. The reinforcement members 3 have a role of ensuring the strength of the heat insulating plate 1 by being in contact with the plate and the platen on the upper and lower end faces (the front side in FIGS. 1A and 1B and the rear side not illustrated in the drawings). In particular, the reinforcement members receive the pressure received from the platen side or the plate side at the time of pressurization, and increases the durability of the heat insulating plate 1.

The reinforcement members 3 are formed in a stripe shape and are formed of a metal material having a thickness of about 1 to 10 mm. As the metal, a material excellent in compressive strength and bending strength, such as iron, stainless steel, or titanium alloy, may be adopted. The multiple reinforcement members 3 are formed in the same shape.

The reinforcement members 3 are mounted to be snugly fitted in the mounting holes 4 formed in substantially the same shape. In order to increase the fixing force between the reinforcement members 3 and the base member 2, it is also possible to use an adhesive between the reinforcement members 3 and the mounting holes 4.

From the viewpoint of further enhancing the heat insulating property of the heat insulating plate 1, it is desirable to dispose an elastic member formed of foamed rubber between the base member 2 and each of the reinforcement members 3, that is, on the inner peripheral surface of each of the mounting holes. As a result, the gap between the base member 2 and each of the reinforcement members 3 is filled with foamed rubber, and the passage of air is blocked, and thus the heat insulating property of the heat insulating plate 1 can be further enhanced. Further, it is possible to improve the holding property of the reinforcement members 3 in the heat insulating plate 1.

Here, the shape of the mounting holes 4 in the base member 2 does not have to be the shape of the through hole formed by hollowing out the solid portion of the base member 2. For example, it is possible to adopt a structure in which notches are formed from the outer peripheral surface side of the base material toward the center through hole side, and the shape of the notch portions is substantially the same as that of the reinforcement members, and the reinforcement members are attached to the base material. In this case, since the reinforcement members may protrude from the notch portions due to vibration or the like during use, it is preferable to fix the reinforcement members to the notches using an adhesive.

The reinforcement members 3 are disposed radially around the center through hole 5 in the base member 2, and respective adjacent reinforcement members 3 are attached such that the spacing therebetween is uniform. That is, multiple reinforcement members 3 are arranged uniformly with respect to the base member 2 in a plan view.

Here, the number of the reinforcement members 3 attached to one base member 2 does not have to be limited, and may be appropriately set in accordance with the area of the base member 2. The reinforcement members 3 may be disposed at positions where the reinforcement members 3 are easily subjected to the pressure applied to the heat insulating plate 1 in accordance with the shapes of the platens and plates of the tire vulcanizer to which the heat insulating plate 1 is attached.

Further, the shape and size of the reinforcement members 3 do not have to be limited to those illustrate in FIG. 1A. For example, as illustrated in FIG. 1B, it is also possible to adopt an aspect in which the number of arranged reinforcement members increases by arranging reinforcement members that have a shape slightly smaller in width than the reinforcement members 3 in FIG. 1B.

Furthermore, as a modification of the shape and arrangement of the reinforcement members 3, the structures illustrated in FIGS. 2A and 2B may also be adopted.

In the heat insulating plate 7 illustrated in FIG. 2A, substantially quadrangular reinforcement members 8 are arranged radially to be spaced apart from each other in the radial direction of the base member 9. In addition, the heat insulating plate 10 illustrated in FIG. 2B has a structure in which substantially fan-shaped reinforcement members 11 are arranged on the base material 13 at regular intervals around the center through hole 12. As described above, it is possible to review various aspects in the shape and arrangement of the reinforcement members.

As to the shape of the reinforcement members and the arrangement positions of the reinforcement members with respect to the base member, it is not necessary to radially arrange the reinforcement members having the same shape in accordance with the formation position of the through hole in the center of the base material as illustrated in FIGS. 1A and 1B or FIGS. 2A and 2B. It is sufficient if the combined area of all of the reinforcement members is an area capable of maintaining the strength required for the entire heat insulating plate. For example, the arrangement positions of the reinforcement members in the base material 2, which are asymmetrical to each other with respect to the center through hole of the base material or the positions where the reinforcement members are randomly arranged may also be adopted. In addition, the shapes of the multiple reinforcement members may be different from each other.

The thickness of the reinforcement members 3 is not necessarily limited to about 1 to 10 mm. For example, when the base material is not a thin sheet-shaped base material but a flat base material having a thickness of several millimeters to several tens of millimeters, reinforcement members having a thickness equal to or larger than that of the base material are adopted.

In the case of using a sheet-shaped base material 2, it is desirable to adopt reinforcement members having a thickness that is equal to or larger than the thickness of the base material 2 and is as close to the thickness of the base material 2 as possible. As a result, when a platen or plate and the reinforcement members 3 are brought into contact with each other, the gap generated between the base material 2 and the platen or plate becomes small, and the heat insulating property can be improved.

Regarding the relationship in thickness between the base member and the reinforcement members, a heat insulating plate may be formed by adopting, for example, a material, which is a material constituting the base material and has compressibility in a material state before completion as the heat insulating plate, and compressing the material of the base material, the thickness of which is greater than that of the reinforcement members before compression, to a thickness equal to or smaller than the thickness of the reinforcement members when integrating the material of the base material with the reinforcement members.

Regarding the thickness of the heat insulating plate, it is important that the reinforcement members be in contact with the platen or plate since it is necessary for the portions having the reinforcement members, which are strong, to receive the force applied by pressure or deformation from the outside.

The reinforcement members 3 are not necessarily formed of a metal member, and any material capable of imparting appropriate strength to the heat insulating plate 1 is sufficient. For example, a heat insulating material composed of a mixture of commercially available glass fiber and resin may be adopted.

The heat insulating material of the mixture of the glass fiber and the resin has physical properties of, for example, a thermal conductivity of 0.12 W/(m·K), a density of 1050 kg/m³, a compressive strength of 86 MPa, a bending strength of 67 MPa, and a water absorption rate of 1.5% (a weight change before and after immersion when immersed in distilled water at room temperature for 24 hours).

The physical properties of the heat insulating material of the mixture of the glass fiber and the resin shown above are superior to those made of metal in terms of heat insulating property in that the thermal conductivity thereof is 0.12 W/(m·K). However, since the heat insulating property in the entire heat insulating plate is mainly ensured by the base material 2, a material having a thermal conductivity value larger than 0.12 W/(m·K) is also acceptable. Meanwhile, regarding strengths, the compressive strength and bending strength are preferably not less than the values of the above-mentioned heat insulating material of the mixture of glass fiber and resin. It is preferable that the water absorption rate is as low as possible, and it is more preferable that the water absorption rate is 1.5% or less.

As described above, the heat insulating plate 1 to which the present disclosure is applied is formed by combining a base material, which is a main material for enhancing the heat insulating property, and a reinforcement member 3 for ensuring strength, so that the heat insulating plate has an adequate heat insulating property and strength required for the tire vulcanizer.

Further, since the heat insulating plate is obtained by combining and integrating a sheet-shaped or flat plate-shaped base material and reinforcement members, it is easy to attach the heat insulating plate to each member in the tire vulcanizer, and it is easy to stably maintain the attached state. That is, even if the orientation of the heat insulating plate (e.g., the state in which the heat insulating plate is inclined with respect to the horizontal direction due to the opened state of the upper plate) changes due to the operating state of the mold of the tire vulcanizer and peripheral devices, it is easy to maintain the attached state of the heat insulating plate. The heat insulating plates of conventional tire vulcanizers include a type in which an existing heat insulating plate is placed between the platen and the plate without being fixed. Such a heat insulating plate may not exert the heat insulating property due to being displaced or falling off from a predetermined position as a result of, for example, the movement of the plate. Compared to such a conventional heat insulating plate, the heat insulating material to which the present disclosure is applied can be sufficiently held between the platen and the plate.

As described above, the heat insulating plate according to the present disclosure has satisfactory heat insulating properties and is also excellent in strength. In addition, the heat insulating structure of a tire vulcanizer according to the present disclosure has satisfactory heat insulating properties and is also excellent in strength. Further, the method of vulcanizing a green tire according to the present disclosure has satisfactory heat insulating properties and is also excellent in strength.

### DESCRIPTION OF REFERENCE NUMERAL

1: heat insulating plate

2: base material

3: reinforcement member

4: mounting hole

5: center through hole

6: mounting through hole

7: heat insulating plate

8: reinforcement member

9: base material

10: heat insulating plate

11: reinforcement member

12: center through hole

13: base material

1. A heat insulating plate comprising:
a base part disposed between a platen and a plate, the plate disposed outside the platen and configured to fasten the container and the platen wherein the base part includes multiple openings formed therein; and
at least one reinforcement member provided at at least one of positions corresponding to the openings in the base part to be in contact with the platen and the plate, the reinforcement member having a thermal conductivity higher than a thermal conductivity of the base part,
wherein the platen is configured to sandwich a container and to supply steam to the container,
wherein the container is configured to clamp, vulcanize, and mold a green tire therein,
wherein each reinforcement member is provided and arranged substantially uniformly from a center of the base part as a starting point.

2. The heat insulating plate of claim 1, wherein the thermal conductivity of the base part is 0.05 W/(m·K) or less.

3. The heat insulating plate of claim 1, wherein the thermal conductivity of the reinforcement member has a value larger than 0.1 W/(m·K).

4. (canceled)

5. The heat insulating plate of claim 1, wherein the multiple reinforcement members have a same thickness.

6. The heat insulating plate of claim 1, wherein an elastic gap filler is disposed between the base member and the reinforcement member.

7. A heat insulating structure of a tire vulcanizer comprising:
a container configured to clamp, vulcanize, and mold a green tire therein;
a pair of platens configured to sandwich the container from above and below to supply steam to the container;
a pair of plates disposed outside the platens, respectively, and configured to fasten the container and the platens; and
a heat insulating plate including a base part interposed between the container and each of the plates wherein the base part includes multiple openings formed therein, and a reinforcement member provided at at least one of positions corresponding to the openings of the base part to be in contact with the platen and the plate,
wherein the reinforcement member having a thermal conductivity higher than a thermal conductivity of the base part, and
wherein multiple reinforcement members are provided and arranged substantially uniformly from a center of the base part as a starting point.

8. A method of vulcanizing a green tire the method comprising:
disposing, when a green tire is clamped, vulcanized, and molded by a mold part of a container, a heat insulating plate,
wherein the heat insulating plate is between the container and a plate to provide heat insulation, the heat insulating plate including a base part having multiple openings therein and at least one reinforcement member provided at at least one of positions corresponding to the openings of the base part to be in contact with a platen and the plate,
wherein the reinforcement member has a thermal conductivity higher than a thermal conductivity of the base part, and
wherein each reinforcement member is provided and arranged substantially uniformly from a center of the base part as a starting point.
